(19) United States
(12) Patent Application Publication
(10) Pub. No.: US 2025/0018636 A1
(43) Pub. Date: Jan. 16, 2025

(54) APPARATUS AND METHOD FOR FORMING PLASTIC PREFORMS INTO PLASTIC CONTAINERS WITH WEAR CHECK OF VALVES

(71) Applicant: KRONES AG, Neutraubling (DE)

(72) Inventors: Frank WINZINGER, Regensburg (DE); Daniel PETER, Hemau (DE); Konrad SENN, Alteglofsheim (DE)

(21) Appl. No.: 18/770,577

(22) Filed: Jul. 11, 2024

(30) Foreign Application Priority Data
Jul. 11, 2023 (DE) 10 2023 118 339.7

(51) Int. Cl. B29C 49/42; B29C 49/78; B29L 31/00; F16K 27/02; F16K 37/00

(52) U.S. Cl. CPC B29C 49/4289; B29C 49/78; F16K 27/02; F16K 37/0058; F16K 37/0083; B29L 2031/712

(57) ABSTRACT

Disclosed is an apparatus for forming plastic preforms into plastic containers with a movable carrier on which a plurality of forming stations for forming the plastic preforms into the plastic containers is arranged, wherein the forming stations each have valve arrangements for applying a flowable medium to the plastic preforms in order to expand them, and wherein each valve arrangement has at least two controllable valve devices, having movable piston devices which can switch the valve devices between at least two valve positions, characterized in that the device has a monitoring device for checking a state of wear of at least one of the valve devices. The monitoring device has at least one detection device which is configured for detecting the state of wear of the valve device optically and without contact.

### BACKGROUND OF THE INVENTION

The present invention relates to an apparatus and a method for forming plastic preforms into plastic containers and to a valve device. The present invention is described with reference to a valve device for controlling blowing air which serves to expand the plastic preforms.

It should be noted, however, that the present invention is also applicable to other valve devices and in particular valves for air. In addition, the invention can also be used for other types of valves which are used for other flowable media, such as water, oil, steam and the like.

Such machines have long been known from the prior art in the form of blow molding machines, for example. These blow molding machines usually have valve arrangements that apply different pressures to the plastic preforms to be expanded. For this purpose, these valve arrangements each have a plurality of valve devices.

In many machines, such valve devices are installed in regions of the machine that are difficult to access. Furthermore, the current state of the art offers hardly any possibilities for monitoring the state of wear of these valves. In the as yet unpublished patent application DE 10 2022 105 440 A1 of the present applicant, an apparatus and a method for checking the wear of such valves were specified. This is based on an electrical check of the state of wear.

The present invention is based on the object of providing a possibility for establishing the state of wear of such valves, in particular an apparatus for forming plastic preforms into plastic containers and in particular plastic bottles.

### SUMMARY OF THE INVENTION

An apparatus according to the invention for forming plastic preforms into plastic containers has a preferably movable carrier on which a plurality of forming stations for forming the plastic preforms into the plastic containers is arranged, wherein these forming stations each have valve arrangements in order to apply a flowable and in particular gaseous medium to the plastic preforms in order to expand them, and wherein each of these valve arrangements has at least two controllable valve devices, wherein these valve devices having movable piston devices which can switch the valve devices between at least two valve positions or which are suitable and intended for switching the valve devices between at least two valve positions.

According to the invention, the apparatus has a monitoring device for checking the state of wear of at least one of the valve devices, wherein this monitoring device having at least one detection device which is suitable and intended for detecting the state of wear of the valve device by means of electromagnetic radiation and/or acoustically and without contact.

Preferably, the state of wear is detected optically, in particular by light. However, an acoustic detection, for example by sound waves and in particular by ultrasound, would also be conceivable. X-rays could also be used. The applicant reserves the right to claim protection for an acoustic detection of the state of wear, in particular by means of sound waves and in particular by means of ultrasound.

Particularly preferably, the movable carrier is a rotatable carrier. The individual forming stations are preferably arranged on this carrier, in particular equidistantly.

The forming stations preferably each have blow molds within which the plastic preforms can be expanded to form the plastic containers.

In addition, the forming stations preferably each have stretching rods that can be inserted into the plastic preforms in order to stretch them in their longitudinal direction.

The individual blow molds can preferably be opened and closed in order to introduce plastic preforms therein and to subsequently apply a flowable medium and in particular compressed air to the plastic preforms. The flowable medium is therefore in particular (compressed) air, but it would also be conceivable for the plastic preforms to be applied with a liquid.

In a further preferred embodiment, the apparatus has at least one pressure reservoir within which the flowable medium can be stored under a predetermined pressure. Preferably, the apparatus has at least two, preferably at least three and preferably at least four pressure reservoirs for different pressure levels. These pressure reservoirs are preferably arranged on the rotatable carrier on which the forming stations are also arranged. In a further preferred embodiment, the pressure reservoirs are ring channels.

Preferably, these pressure reservoirs can be fluidically connected to the valve arrangements of the individual forming stations. In this way, it is possible for different pressures to be applied to the individual forming stations via the valve arrangements starting from the individual pressure reservoirs.

The individual forming stations preferably each have application devices in order to apply the individual pressures to the plastic preforms. These application devices are preferably movable in a longitudinal direction of the plastic preforms and can be fed to the mouths of the plastic preforms. In addition, it is also conceivable that the application device is fed to a carrier ring of the plastic preforms or to a blow mold within which the plastic preform is located.

In a further preferred embodiment, the detection device is suitable and intended for capturing a spatially resolved image of at least one component of a valve device. The detection device can, for example, be a camera or another image capturing device.

Preferably, the component of the apparatus is the above-mentioned piston device and in particular an end portion of this piston device. However, the component may also be a valve seat against which the piston device is supported in a position of the valve device or against which the piston device temporarily rests. Preferably, the piston device or an end portion thereof is made of a softer material than the valve seat. Preferably, wear is checked on the component that is made of a softer material.

Preferably, the apparatus has an evaluation device which evaluates at least one image of the valve device captured by the detection device. This evaluation can preferably be used to determine the state of wear of the valve device and in particular of the valve piston.

In a preferred embodiment, the valve device is a pneumatically or electrically operated valve or a solenoid valve or a magnetically operated valve. In a preferred embodiment, the valve device comprises a control valve or a pilot valve. This control valve is preferably an electrically operated or a pneumatically operated valve.

In a preferred embodiment, the detection device is suitable and intended for detecting a state of the valve device in a predetermined state of the valve device, for example in an open or closed state of the valve device. It is possible to monitor the state of wear during operation and/or online. However, it is also possible for the state of wear to be monitored during maintenance of the apparatus or in response to an error message.

In a further preferred embodiment, at least one valve device has a housing within which the piston device is movable and the detection device is suitable and intended for detecting the state of wear of the valve device through a wall of this housing or the detection device is integrated into this housing and in particular into a wall of this housing.

In one embodiment, the detection device is arranged outside the housing and can detect the state of wear of the piston device and/or a valve seat through a component of the housing wall. For this purpose, the detection device can preferably capture at least one image of this piston device and/or the valve seat.

However, it would also be possible for the detection device to be integrated directly into the housing, in particular into a wall of the housing. For example, an observation window of the detection device can also form a portion of an inner wall of the valve device.

Preferably, however, the valve device can be removed from the housing and/or mounted thereon. If the detection device is integrated into the housing, it is preferably integrated into a region of the housing in which there are no sealing devices (such as O-rings and the like) or guide devices for guiding the valve piston, which seal the piston device relative to the housing.

In a further advantageous embodiment, the housing has at least one wall portion that is transparent to light, in particular to visible light, and preferably the detection device is suitable and intended for observing the state of wear of the valve device through this transparent wall portion. In this embodiment, it is also possible for a machine operator to check the state of wear instead of the detection device or in addition to the detection device.

In this way, the detection device can preferably capture an image of the piston device and/or the valve seat through this wall portion. It would also be conceivable, however, for the entire housing of the valve device to be made of a material that is transparent (in particular to visible light). Preferably, however, the material is resistant to cleaning agents and/or sterilizing agents.

For example, the wall portion or the housing can be made of glass or plastics, such as PET.

Preferably, the housing is closed at least in the region in which this wall portion is located.

In a preferred embodiment, the detection device is arranged and/or positioned such that it can fully observe at least a portion and in particular an end portion of the piston device. In this way, the state of wear of the piston device can be fully determined.

In a preferred embodiment, the detection device is arranged and/or positioned such that it can fully observe at least a portion of a valve seat. In this way, the state of wear of the valve seat can be fully determined.

In a further preferred embodiment, the apparatus has a control device which is suitable and intended for controlling and/or regulating the apparatus on the basis of at least one value output by the detection device and/or the apparatus has at least one processor device which is suitable and intended for evaluating at least one value output by the detection device and for outputting a signal which is characteristic of a state of wear of the valve device.

In a preferred embodiment, the apparatus and in particular the control device has a storage device in which images of valve parts and in particular of piston devices and/or valve seats are stored.

Particularly preferably, the apparatus has a comparison device which is suitable and intended for comparing images captured of the piston device and/or a valve seat with stored images, in particular in order to be able to output information which is characteristic of the state of wear of the valve device.

For example, an indication can be given of an impending failure of the valve device. The user can also be provided with information about the expected remaining service life of the valve device.

Preferably, the spatially resolved image(s) is/are stored in a storage device. This storage device is preferably a cloud. Preferably, images of other machines will also be stored in this storage device, and in particular in a cloud, wherein these other machines are preferably identical machines or machines with identical valves.

In a further preferred embodiment, a signal can also be output when wear has already occurred but the valve is still functional. This allows the operator to order a part to be replaced before the machine stops. Optionally, the part can also be ordered automatically.

It would also be conceivable for such a signal to be sent to a mobile device.

In a further preferred embodiment, the detection device is arranged in a stationary manner relative to the valve device. For example, the detection device can be arranged in a fixed position in which it is always suitable for detecting the state of the piston device and/or the valve seat and/or in which it can always capture an image of the valve device.

In a further preferred embodiment, the detection device is arranged to be movable relative to the valve device.

Preferably, the detection device is arranged to be movable such that it can monitor the states of wear of several valve devices. In this way, it is possible for several valves to be detected by means of one detection device.

In a preferred embodiment, the detection device is suitable and intended for detecting at least one information and/or identification which is characteristic of a forming station to which the valve devices are assigned. This can be a station number of this forming station or an individual marking which is arranged on the forming station, such as a QR code or the like. In this way, values determined for a specific valve device can also be assigned to a specific forming station. This makes it possible to later determine which forming station is showing wear.

In a further preferred embodiment, the detection device can be guided on a robot arm. For example, several valve devices can be monitored in a maintenance operation.

The detection device can be arranged on a mobile robot. The mobile robot can have several wheels or legs with which it is movable. Alternatively, the mobile robot can be a drone that transports the or a detection device. The mobile robot can check or detect by sensor not only the valves of one valve device, but also of a plurality of valve devices.

The valve devices can be arranged on a movable carrier, e.g., a blowing wheel, along its circumference. By rotating the blowing wheel, the individual valve devices or valves of a or the detection device can be presented one after the other.

Alternatively, by means of a mobile robot, a or the detection device can be moved along the circumference of a blowing wheel in order to check a plurality of valve devices.

A mobile robot with a or the detection device can detect a plurality of valve devices of different apparatuses for forming plastic preforms into plastic containers.

In a further preferred embodiment, the detection device is suitable and intended for monitoring the states of wear of several valve devices. This detection device can also be arranged in a stationary manner relative to the valve devices. For example, a detection device can be arranged above several valve devices of a valve arrangement and detect the valve pistons of several valve devices.

Particularly preferably, the valve arrangement is designed such that a rod-like body, in particular the above-mentioned stretching rod, can be guided through this valve arrangement.

As mentioned above, in addition to the optical methods, the state of wear can preferably also be determined by a detection device which is suitable and intended for detecting this state electromagnetically and/or acoustically and in particular by electromagnetic radiation and/or acoustics.

As part of an electromagnetic check of the state of wear, the detection device preferably has inductive and/or capacitive sensors. Preferably, an inductive and/or capacitive position detection of at least a portion and in particular of an end portion of the piston device and/or at least a portion of a valve seat is carried out. The location or position of the piston device and/or the valve is thus detected.

In addition, the state of wear of the valve device can preferably also be checked by a leak test, for example by measuring the flight time of the valve, i.e., the switching time between leaving the start position and reaching the end position. From this flight time, conclusions can be drawn about the proper functioning of the valve.

Such a wear check with inductive and/or capacitive sensors can preferably be carried out on an electrically operated pilot valve and/or on a pneumatically operated main valve.

The checking or detecting of the state of wear can preferably be carried out by a self-learning system, such as artificial intelligence (AI), wherein a test run can preferably be carried out and the AI is trained on certain or predetermined patterns which correspond to a state of wear and/or a good condition of the components in question. This can also be done via so-called DoE (Design of Experiments).

The evaluation of the data collected by the acoustic sensor and/or AI is preferably carried out centrally on the system or decentrally at another location and is then transmitted to the system or an operator.

If the evaluation reveals that an error has occurred and/or that a specific or foreseeable error will occur in the near future, an error message can preferably be issued. The error message can preferably be an acoustic and/or optical signal to the operator via an operating terminal or via signal lights on the system. Preferably, a recommendation for action can be issued together with the error message, such as a recommendation to order spare parts or replace certain parts.

Characteristic values or limit values are preferably specified for the state of wear and, in particular, limit ranges within which the measurement results should lie. If these values are exceeded or not met, this may be an indication that wear is occurring. Preferably, a dynamic limit value adjustment can also be carried out so that the limit values are adjusted depending on requirements or changing environmental conditions, preferably automatically.

These inductive and/or capacitive measurements can preferably also take place outside the optical spectrum, e.g., in the IR range. For example, additional wear parameters can be identified via the heat distribution in or on the valve piston, which can provide information about preferred future wear.

X-ray methods are also conceivable, with which, depending on the design of the piston, an internal structure and in particular a material structure of the piston can be checked. Preferably, such X-ray methods could be used to check the material, for example to be able to identify weak points in the material, in particular of the piston, at an early stage.

In addition, the detection device can preferably also have acoustic sensors for checking wear. Preferably, an acoustic position detection of at least a portion and in particular of an end portion of the piston device and/or at least a portion of a valve seat is carried out. The location or position of the piston device and/or the valve is thus detected. This is preferably done by measuring or detecting vibrations and/or vibration times, for example the impact of the piston or by measuring the grinding noise/sliding noise in the valve seat and identifying the position of the piston.

Preferably, the acoustic sensors can also be used to check the wear over a switching time of the valve device, wherein the switching time and the stop time of the piston are preferably detected acoustically and the time in between is measured.

As with the inductive and/or capacitive sensors, the acoustic sensors can also preferably be used to determine the state of wear via the tightness, for example by detecting leakage noises when the valve device is actually closed. For example, frequency bands can be analyzed by a user or automatically by the evaluation device.

Preferably, the acoustic sensor is connected to a high-pass and/or low-pass filter, which masks out unwanted background noise that could otherwise complicate the acoustic inspection. For example, flow noise from the pilot valve and/or the main valve could be masked out or, as mentioned above, analyzed to detect unusual noises.

In order to check the state of wear of the valve device, in a preferred embodiment, a membrane is arranged on an outer side of the valve block or in the interior of the blowing air channel, by which acoustic vibrations can be recorded, comparable to a microphone.

In a further preferred embodiment, the state of wear is checked using acoustic methods by arranging a pickup. Preferably, each valve block has at least one pickup and particularly preferably each valve device or each valve has at least one such pickup.

As already mentioned above, software or artificial intelligence (AI) can also be used to detect and/or check the state of wear of the valve devices.

Preferably, the AI is trained with a plurality of good pistons and/or good seals and worn pistons and/or seals in order to be able to recognize these conditions. The Al can also preferably be provided with an analysis of the measured or collected data from a plurality of stations/machines and these results can preferably be used to evaluate the state of wear and/or to predict wear. Preferably, a plurality of different measurement data, such as images and acoustic measurement data, is used for this purpose and in particular for training the AI.

These data can preferably be overlaid with additional (measurement) data, such as the blowing pressure curve (in particular its slope) and/or the number of blowing cycles and/or data concerning the bottle quality, for example wall thickness measurement or material distribution.

If necessary or possible, the AI regulates for example pilot valves in such a way that they control the piston in a gentler manner, for example by reducing the pressure build-up so that the piston does not hit the seat so quickly. However, this regulation should not impair the bottle quality. In parallel, the AI can also preferably adjust the stretching speed at switching times of the P1 pilot valves.

The regulation or control is therefore preferably carried out by the AI in such a way that it determines the optimal operating point between the bottle quality and the valve switching times and controls them accordingly. Preferably, the results of the above-mentioned heat determination in the valve piston in the IR range, for example, could also be used to determine these switching times.

The described electromagnetic and acoustic methods for checking the state of wear are advantageous because they allow valve wear to be identified at an early stage.

The present invention is further directed to a valve device, in particular for an apparatus of the type described above, wherein these valve devices have a media inlet for a flowable medium and a media outlet for the flowable medium and a linearly movable piston device which is movable between at least two positions of the valve device, wherein in one of the two positions a media flow of the flowable medium from the media inlet to the media outlet is enabled and in the other of the two positions a media flow of the flowable medium from the media inlet to the media outlet is (substantially) prevented or throttled.

This valve device has a housing within which the piston device is movable.

According to the invention, at least a portion of the piston device and/or a valve seat can be observed by an optical detection device and in particular can be observed through a region of the housing.

The present invention is further directed to a monitoring apparatus for monitoring a state of wear of a valve device. This has a valve device of the type described above and a detection device which is suitable and intended for detecting at least a state of wear of the piston device and/or the valve seat.

Preferably, the detection device is suitable and intended for capturing a spatially resolved image of the piston device and/or the valve seat.

In a further preferred embodiment, the monitoring apparatus has an evaluation device in order to determine a state of wear of the valve device from a captured image of the piston device and/or the valve seat.

The present invention is further directed to a method for forming plastic preforms into plastic containers, wherein a movable and in particular rotatable carrier, on which a plurality of forming stations for forming the plastic preforms into the plastic containers is arranged, transports these plastic preforms, wherein these forming stations each have valve arrangements by which a flowable and in particular gaseous medium is applied to the plastic preforms (10) in order to expand them, and wherein each of these valve arrangements (80) has at least two controllable valve devices (60), wherein these valve devices having movable piston devices which switch the valve devices between at least two valve positions.

According to the invention, a monitoring device is provided for checking a state of wear of at least one of the valve devices, wherein this monitoring device has at least one detection device which optically detects at least one element of the valve device in order to detect and/or determine the state of wear of the valve device optically and without contact.

Particularly preferably, this detection device captures at least one spatially resolved image of the valve device and in particular of the piston device and/or a valve seat (for this piston device). Preferably, an evaluation device evaluates this spatially resolved image in order to determine the state of wear of the valve device.

The invention is further directed to a method for monitoring, in particular a state of wear, of a valve device of a forming station comprising the following steps:
Switching the valve device to release a pressurized medium and in particular a gaseous medium;
Forming plastic preforms into plastic containers using the medium;
Detecting a region of the valve device with a detection device;
Capturing and storing image data with the detection device;
Generating a digital image;
Analyzing the image or image data with an evaluation device;
Optionally initiating measures when an error is detected;

The detection device is preferably a digital camera.

Furthermore, the above-mentioned advantageous embodiments and methods are also applicable to this method. For example, the evaluation can be carried out using artificial intelligence, as described above.

Preferably, the region of the valve device is a valve piston and/or a portion and in particular an end portion of this valve piston.

Preferably, the pressurized medium can be introduced into a plastic preform to be expanded.

### BRIEF DESCRIPTION OF DRAWINGS

Further advantages and embodiments can be seen in the accompanying drawings:

In the drawings:

FIG. 1 shows a first embodiment of a valve device according to the invention;

FIG. 2 shows a wear situation of the valve device shown in FIG. 1;

FIG. 3 shows a second embodiment of a valve device according to the invention;

FIG. 4 shows a fourth embodiment of a valve device according to the invention;

FIG. 5 shows a fifth embodiment of a valve device according to the invention;

FIG. 6 shows a sixth embodiment of an apparatus according to the invention;

FIG. 7 shows a valve arrangement with a plurality of valve devices; and

FIG. 8 shows a representation of an apparatus according to the invention for forming plastic preforms into plastic containers.

### DETAILED DESCRIPTION OF INVENTION

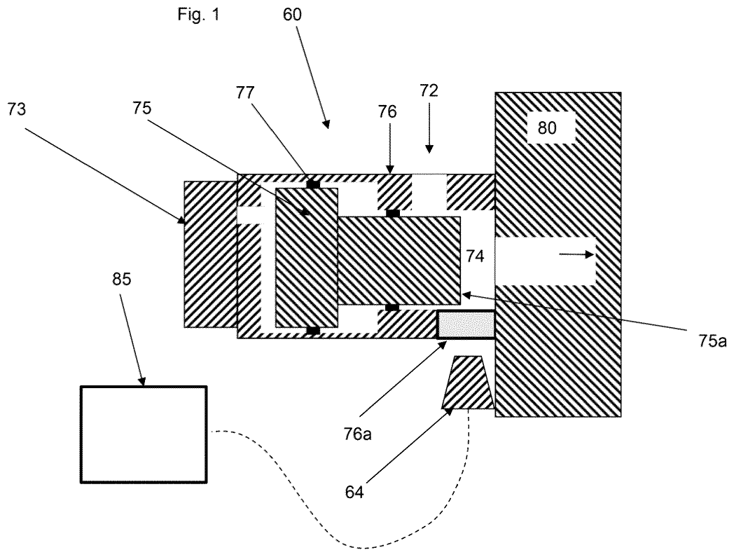

FIG. 1 shows a valve device 60 in a first embodiment. The reference sign 75 refers to a valve piston which is linearly movable between two end positions. The reference sign 72 designates a media inlet via which compressed air can be supplied to the valve device. The reference sign 74 designates a media outlet via which, in an open state of the valve device, the air present at the media inlet or pressure inlet 72 can be forwarded, in particular to a blow mold.

The reference sign 76 designates a housing of the valve device 60, within which the piston device 75 is movable. The reference sign 77 designates guide devices for guiding the piston device relative to the housing.

The reference sign 75a designates sealing surfaces of the piston device 75, which are made of a softer material here, such as a valve seat for the piston device 75. In this embodiment, these sealing surfaces 75a are therefore subject to wear. FIG. 1 shows a valve device with a non-worn piston in an open state.

The reference sign 80 designates the valve arrangement which carries the individual valve devices and the reference sign 73 designates a pilot valve. This can be designed, for example, as an electric or pneumatic valve.

The reference sign 76a designates a transparent portion of the housing wall. Through this portion, a detection device, such as a camera, can look into the interior of the housing 76 and in particular at the piston device 75 and there in particular at its sealing surface.

The reference sign 85 as a whole designates an evaluation device for evaluating the images captured by the detection device 64.

In addition, a control device for controlling a corresponding apparatus, a PLC, LMS, an Internet connection, a cloud, a database and/or a comparison device can also be provided.

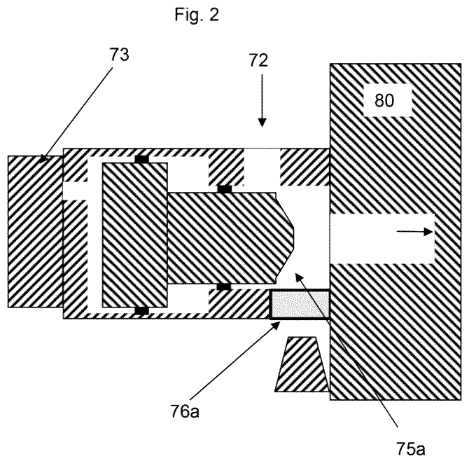

FIG. 2 shows a further situation of the apparatus shown in FIG. 1. Here, the valve device is also open, but the piston device is worn, which can also be detected by the detection device.

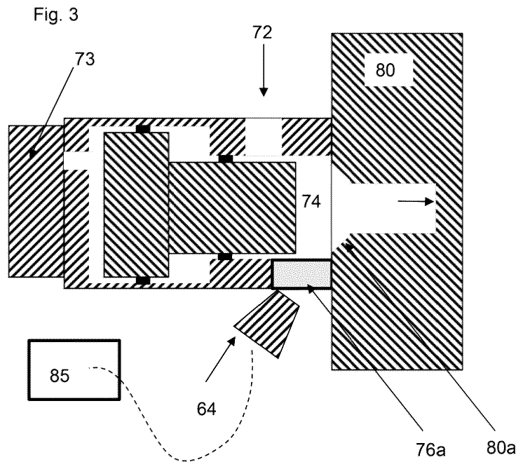

FIG. 3 shows a further embodiment of a valve device according to the invention. In this embodiment, the piston device 75 is made of a comparatively hard material, but the sealing surfaces 80a or the valve seat are made of a soft material and are therefore subject to wear. In this embodiment, the detection device 64 looks through the transparent wall portion onto the sealing surfaces 80a of the valve arrangement. Accordingly, the images captured of the sealing surfaces are preferably evaluated here.

FIG. 3 shows the situation of an open valve device with worn sealing surfaces 80a.

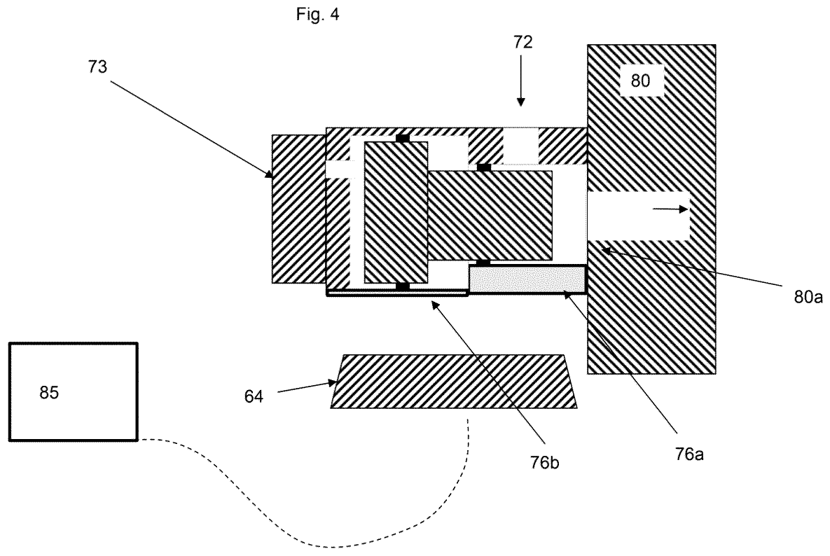

FIG. 4 shows a further embodiment of an embodiment according to the invention. Here too, the sealing surfaces 85a are the wear surfaces and are observed and detected accordingly. In addition, however, other regions of the piston device 75 can also be detected here, for which purpose a further transparent housing portion 76b is preferably provided. The detection device 64 can preferably have a larger field of view or two detection devices could also be provided.

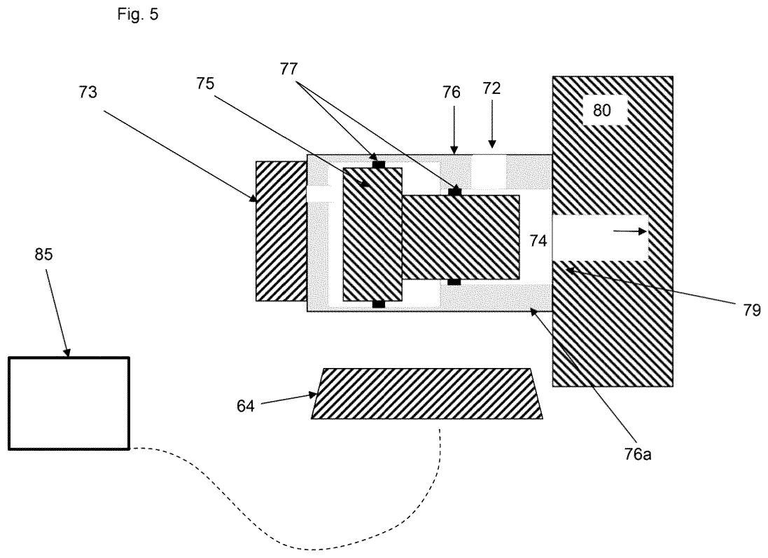

FIG. 5 shows a further embodiment of a valve device according to the invention. In this embodiment, the entire housing 76 is preferably transparent. In this case, the valve device or its interior can be viewed from several sides. In this way it would be possible, for example, to monitor both the piston device 75 and its guides 77. It is also possible to monitor the valve seat here.

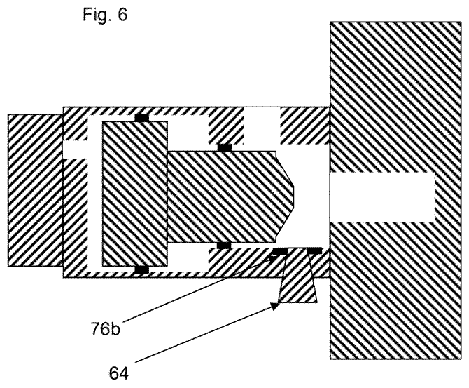

FIG. 6 shows a further embodiment of the apparatus according to the invention. In this embodiment, the detection device does not detect the piston device and/or the interior of the housing “from the outside” but is inserted into a recess. In this way, the detection device can directly observe the piston device and/or the valve seat. In this embodiment, the detection device, for example a camera, is therefore a component of the housing of the valve device.

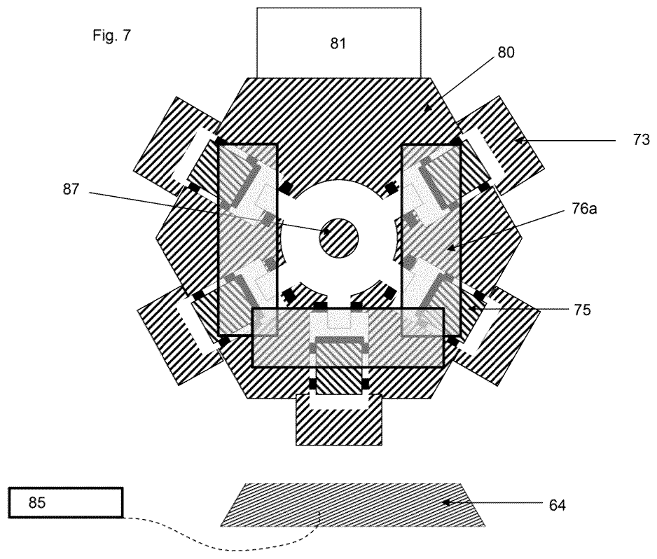

FIG. 7 shows a valve arrangement with a plurality of valve devices. Transparent wall portions of the housing are provided on an upper side of the valve arrangement. A detection device 64 can preferably monitor the internal workings and in particular the piston devices and/or valve seats of several and preferably all valve devices. Preferably, the detection device looks obliquely from above at the viewing window or the transparent wall portions from outside the image plane.

The reference sign 87 refers to a rod-like body or the above-mentioned stretching rod, which is movable within the valve arrangement and in particular movable in a longitudinal direction of the plastic preforms to be expanded.

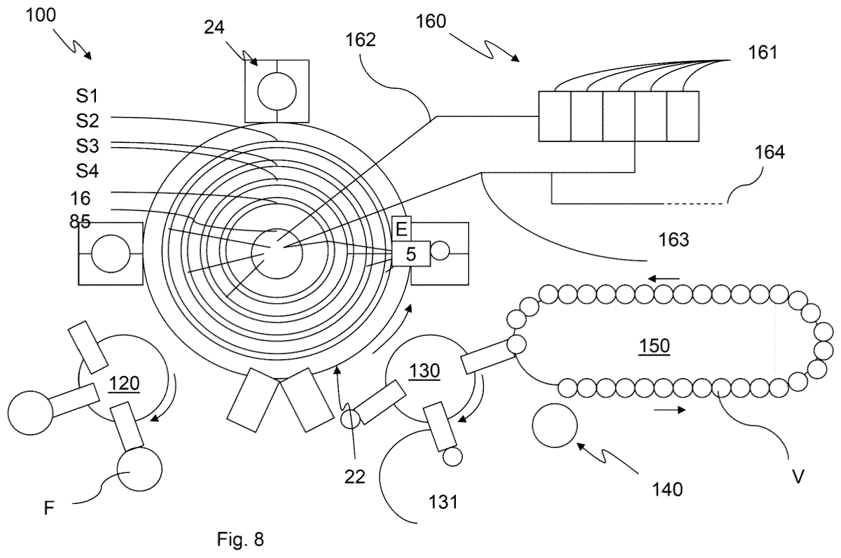

FIG. 8 is a schematic plan view of a container handling machine or an apparatus for forming plastic preforms into plastic containers in the form of a hollow body manufacturing machine 100. In this exemplary embodiment, it is designed as a continuously operating stretch blow molding machine. Preforms V are fed via a so-called sawtooth starwheel 140 to a tempering apparatus 150, in which the preforms V are preferably continuously passed through a heating tunnel (not shown in detail), advantageously consisting of a plurality of infrared heaters and opposing reflectors, by heating mandrels arranged on a rotating chain.

The tempering apparatus 150 may alternatively be a rotary machine on whose circumference a plurality of heating stations, such as microwave resonators or heating pockets, are mounted (not shown).

After tempering, the preforms V are transferred by grippers 131, which rotate on an inlet starwheel 130, to a blowing wheel 22, on the circumference of which a plurality of blowing stations or forming stations 24 is arranged.

After the forming process in the blowing station 24, the finished blown bottles F are removed by a removal starwheel 120. The bottles F are then transported to a labeling, filling and packaging facility (not shown). The transport paths of the preforms V and the bottles F are each indicated by arrows.

The individual forming stations or blowing stations 24 are supplied with a gaseous medium, here compressed air, via a compressor 160 with several compressor stages 161. In the first stage (shown on the right), air is compressed to a pressure of, for example, 5 bar, in the next stage to 10 bar and so on, until it has a pressure of 45 bar after the final stage.

The air is then fed via a supply line 162 to a rotary distributor 165, which connects the stationary part of the hollow body manufacturing machine 100 to the rotating part (blowing wheel 22). The rotary distributor 165 preferably also has several pressure reducers (not shown), which reduce the pressure provided by the compressor 160 to different pressure levels for ring lines S1 to S3, which are also preferably attached to the blowing wheel 170.

The ring lines S1, S2, S3 serve as pressure accumulators and/or distributors for the individual blowing stations 24 on the blowing wheel 22. In the ring line S3, a pre-blowing pressure of, for example, 10 bar is provided, in the ring line S2 an intermediate blowing pressure of, for example, 20 bar is provided and in the ring line S1 a finished blowing pressure of, for example, 35 bar is provided.

Each blowing station or forming station 24 comprises a valve unit or valve arrangement 80 which is connected to the individual ring lines S1, S2, S3 and which connects the individual ring lines S1, S2, S3 to the preform V to be blown. After sealing the preform V by a blowing nozzle or application device, it is connected to the individual ring channels one after the other and in the following order: S1, S2, S3.

After expansion is complete, the air from the bottle F—still under the final blowing pressure—is preferably first returned to the ring channel S2, advantageously until the pressure in the bottle F has approximately reached the pressure in the ring channel S2. The air in the bottle F—now under approximately the same pressure as the ring channel S2—is subsequently fed to the channel S3.

It may also be advantageous to first use the pre-blowing channel S3 for air return if it is to be ensured that a minimum pressure is always provided in this channel. The return time can also be regulated via the pressure in a channel S2, S3, S4 by a pressure sensor (not shown).

The pressure reducers, which preferably provide the pressure for the channels S2 and S3, could also be dispensed with during manufacture if sufficient air volume is recycled, but they are advantageous for starting up the blow molding machine.

As an alternative to the blow molding machine, the invention can also be used in a filler (or in its product valves, CIP valves, gas valves, etc.) or in all valves for controlling CIP media or product in the process technology part of the beverage processing process technology components, in particular in valve nodes.

This also includes disc, seat and double seat valves. For example, a double seat valve housing film could consist at least partially of a transparent material and thus the seal could be monitored.

The mentioned mobile robot with camera/sensor could also check the valves on fillers and process technology valves. To check for wear, it would also be possible for the mobile robot to remove the valves and inspect them in their removed state. The valves can be attached with a quick-release fastener. Where appropriate, the content of the cited prior art should also be part of the invention.

Instead of now allowing the remaining air to escape into the atmosphere via an outlet E, the blowing air is then fed back into the channel S4 up to a level of 3-5 bar. Since the pre-blowing from the channel S3 under a certain pressure of 10 bar must represent the first step in the manufacture of the hollow body, the ring channel S4, due to its lower pressure level, serves in this exemplary embodiment exclusively for the (intermediate) storage or forwarding of returned blowing air from the bottle F and not for blowing.

From there, the air can either be made available on the blowing wheel 22, for example pilot valves 9 or other drives of the blowing stations (e.g., a drive for stretching rods), or can be transferred via another line and through the rotary distributor 165 back to the stationary part of the machine via line 163. From there, the air can, for example, be fed back to an intermediate stage of the compressor 161 or fed via a line 164 to the hall compressed air network or to other uses, such as bottle bottom post-cooling, or to a labeling or filling machine.

The ring lines S1, S2, S3, S4 can also be ring-shaped only in certain regions. For example, a ring channel S1, S2, S3, S4 can also be formed by two semicircular halves. In general, the pressure accumulators will be referred to as S in the following.

The outlet E mentioned above is present at each station Bs and serves to discharge the remaining 3-5 bar in the bottle F before the blow nozzle 8 is raised again and the bottle F is removed.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for forming plastic preforms into plastic containers with a preferably movable carrier on which a plurality of forming stations for forming the plastic preforms into the plastic containers is arranged, wherein these forming stations each have valve arrangements for applying a flowable medium to the plastic preforms in order to expand them, and wherein each of these valve arrangements has at least two controllable valve devices, wherein these valve devices having movable piston devices which can switch the valve devices between at least two valve positions,
the apparatus has a monitoring device for checking a state of wear of at least one of the valve devices, wherein this monitoring device has at least one detection device which is configured for detecting the state of wear of the valve device by electromagnetic radiation and/or acoustically and without contact.

2. The apparatus according to claim 1,
wherein
the detection device is configured for capturing a spatially resolved image of at least one component of a valve device.

3. The apparatus according to claim 1,
wherein
at least one valve device has a housing within which the piston device is movable and the detection device is configured for detecting the state of wear of the valve device through a wall of this housing or the detection device is integrated into this housing.

4. The apparatus according to claim 1,
wherein
the detection device is or has an image capturing device.

5. The apparatus according to claim 3,
wherein
the housing has at least one wall portion that is transparent to light.

6. The apparatus according to claim 1,
wherein
the detection device is configured for detecting a state of wear of the valve piston.

7. The apparatus according to claim 1,
wherein
the apparatus has a control device which is configured for controlling the apparatus on the basis of at least one value output by the detection device and/or the apparatus has at least one processor device which is configured for evaluating at least one value output by the detection device and for outputting a signal which is characteristic of a state of wear of the valve device.

8. The apparatus according to claim 1,
wherein
the detection device is arranged in a stationary manner relative to the valve device, or the detection device is arranged to be relatively movable relative to the valve device.

9. A valve device, wherein said valve device has a media inlet for a flowable medium and a media outlet for the flowable medium and a linearly movable piston device which is movable between at least two positions of the valve device, wherein in one of the two positions a media flow of the flowable medium from the media inlet to the media outlet is enabled and in the other of the two positions a media flow of the flowable medium from the media inlet to the media outlet is prevented, and having a housing within which the piston device is movable,
wherein
at least a portion of the piston device and/or a valve seat can be observed by an optical detection device through a region of the housing.

10. The valve device according to claim 9,
wherein
the housing has at least one transparent housing portion through which the portion of the piston device and/or a valve seat can be observed and/or the housing has a recess into which the detection device can be inserted.

11. The valve device according to claim 9,
wherein
the valve device is a pneumatically or electrically controlled valve device.

12. A monitoring device for monitoring a state of wear of a valve device with a valve device according to claim 9 and with a detection device which is configured for detecting at least one state of wear of the piston device and/or the valve seat.

13. A method for forming plastic preforms into plastic containers, wherein a movable carrier, on which a plurality of forming stations for forming the plastic preforms into the plastic containers is arranged, transports these plastic preforms, wherein these forming stations each have valve arrangements by which a flowable medium is applied to the plastic preforms in order to expand them, and wherein each of these valve arrangements has at least two controllable valve devices, wherein these valve devices having movable piston devices which switch the valve devices between at least two valve positions,
wherein
a monitoring device is provided for checking a state of wear of at least one of the valve devices, wherein this monitoring device has at least one detection device which optically detects at least one element of the valve device in order to detect and/or determine the state of wear of the valve device optically and without contact.

14. A method for monitoring a valve device of a forming station having the following steps:
switching the valve device to release a pressurized medium;
forming plastic preforms into plastic containers using the medium;
detecting a region of the valve device with a detection device;
capturing and storing image data with the detection device;
generating a digital image with the image data;
analyzing the image or image data with an evaluation device; and
optionally initiating measures when an error is determined.
